(19) United States
(12) Patent Application Publication
(10) Pub. No.: US 2005/0286396 A1
(43) Pub. Date: Dec. 29, 2005

(54) Temperature sensing apparatus and methods for servo and write compensation in a data recording module

(76) Inventors: Craig Raese, Boise, ID (US); Donald Fasen, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/877,333

(22) Filed: Jun. 24, 2004

(51) Int. Cl. G11B 9/00

(52) U.S. Cl. 369/126

(57) ABSTRACT

Apparatus and methods are provided for a data recording module having an electronics die and a read/write die for writing and detecting data in a media die adjacent to the read/write die. A first temperature sensor is disposed in the read/write die to measure a first temperature. A second temperature sensor is disposed in the electronics die or the media die to measure a second temperature. A controller is provided, in electrical communication with the first and second temperature sensors, to generate a control signal to the electronics die in response to a difference between the first and second temperatures. The control signal is provided to servo electronics that operate a servo mechanism which modifies the position of the media die relative to the read/write die to compensate for a change in ambient temperature and maintain optimal operation of the data recording module. If the difference in temperature between the read/write die and the electronics die exceeds a predetermined limit, data writing on the media die ceases until the temperature difference drops back to a safe level.

### FIELD OF THE INVENTION

The present invention relates generally to temperature sensing apparatus and methods. In particular, the present invention relates to apparatus and methods for temperature sensing for servo and write compensation in a data recording module.

### BACKGROUND

Electronic devices, such as palm computers, digital cameras and cellular telephones, are becoming more compact and miniature, even as they incorporate more sophisticated data processing and storage circuitry. Moreover, types of digital communication other than text are becoming much more common, such as video, audio and graphics, requiring massive amounts of data to convey the complex information inherent therein. These developments have created an enormous demand for new storage technologies that are capable of handling more complex data at a lower cost and in a much more compact package. Efforts are now underway to adapt technology to enable the storage of data on scale of nanometers to tens of nanometers, sometimes referred to as atomic resolution storage (ARS).

Several challenges arise in attempting to store data at the ARS level. On that scale, reading and writing data by electron beams or by mechanically detecting data locations on the recording media are increasingly delicate operations much more likely to be affected by error. Such data error can arise from temperature variations, stray electrons, atoms or molecules, extraneous noise and straying from the center of a data track.

In ARS data recording and detection systems, data may be written and detected along recording tracks formed on the data-recording media layer in the form of discrete data locations. These data systems may take many forms, including contact recording mechanisms and energy beam emission systems. In contact recording systems, data pits are formed in data storage media and detected by a contact mechanism, such as a probe mounted on a cantilever. For energy beam emission systems, a plurality of energy beams, electrons or light beams, are emitted toward data storage media to change the state of the media at data locations. Detection of data is achieved by the emission of lower level energy beams.

The probes and cantilevers or the energy beam emitters in ARS data systems may be disposed in a stationary read/write unit above the recording media. A servo-mechanism, such as a micro electromechanical system, may move the media unit, so that each probe or emitter writes or detects data along a plurality of recording tracks. In ARS technology, the data storage and recording system is so small that it is very difficult to maintain accurate mechanical tracking. For example, the width of a recording track may be about 30-35 nm wide and the interval between adjacent recording tracks may be 40-50 nm. Accordingly, it is very important to maintain alignment between the stationary read/write unit and the moving media unit. A reading that is even slightly off-track can result in poor data recovery and inconclusive sensing. Even more important, data writing off-track can destroy an adjacent track of data.

In ARS data systems, the servo system and the read/write unit are likely to be temperature sensitive. This sensitivity may be manifest in the expansion or contraction of the respective units. For various reasons, the ambient temperature at the read/write unit may be different than the temperature at the media unit. In the event that the temperature in one unit is substantially different than that other unit (a few degrees), the resultant gradient in temperature between the units may lead to misalignment. Thus, variations in the ambient temperature in the vicinities of the probe or emitter and data points may detrimentally affect the data read function and may crucially affect the write process, resulting in the destruction of data.

Temperature sensors have been used in disc drive data storage systems, for example in U.S. Pat. No. 6,266,203 (Street et al). As the operational temperature of the system changes, a signal is generated by the sensor that changes appropriate parameters in the system to maintain optimal operating conditions. Such macro adjustments to select different operational parameters are not practical in micro-sized ARS systems.

In ARS data systems, small undetected difference in temperature between the cantilever die and the mover on the rotor die can cause displacement errors between the servo position measured by the servo system and the position of the data emitters or cantilevers, resulting in data read/write errors. Moreover, temperature differences between the probe or emitter tip temperature when writing data and the probe or emitter tip temperature when reading data can be very small. Accordingly, accurate temperature sensing in ARS data storage systems is particularly crucial.

### SUMMARY OF THE INVENTION

In one embodiment of the present invention, a data recording module has an electronics die and a read/write die for writing and detecting data in a media die adjacent to the read/write die. A first temperature sensor is disposed in the read/write die to measure a first temperature. A second temperature sensor is disposed in the electronics die or the media die to measure a second temperature, and a controller in electrical communication with the first and second temperature sensors generates a control signal to the electronics module in response to a difference between the first and second temperature.

In another embodiment of the present invention, a method is provided for writing and detecting data using a data recording module having a having a read/write die, a media die, and an electronics die. A first temperature is measured with a first temperature sensor disposed in the read/write die. A second temperature is measured with a second temperature sensor disposed in the electronics die or the media die. A control signal to the electronics die is generated in response to a difference between the first and second temperature.

### BRIEF DESCRIPTION OF THE DRAWINGS

FIG. 1 is a diagram illustrating an embodiment of a memory module used in connection with embodiments of the present invention.

FIGS. 2 and 3 are simplified plan views of data detection and recording systems used in connection with embodiments of the present invention;

FIG. 4 is a simplified block diagram showing the apparatus used in one embodiment of the present invention;

FIG. 5 is a simplified layout of a die arrangement for the embodiment of FIG. 4;

FIG. 6 is a simplified circuit diagram of a temperature sensor for the embodiment of FIG. 4; and

FIG. 7 is a flow diagram showing functions of the embodiment shown in FIG. 4.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

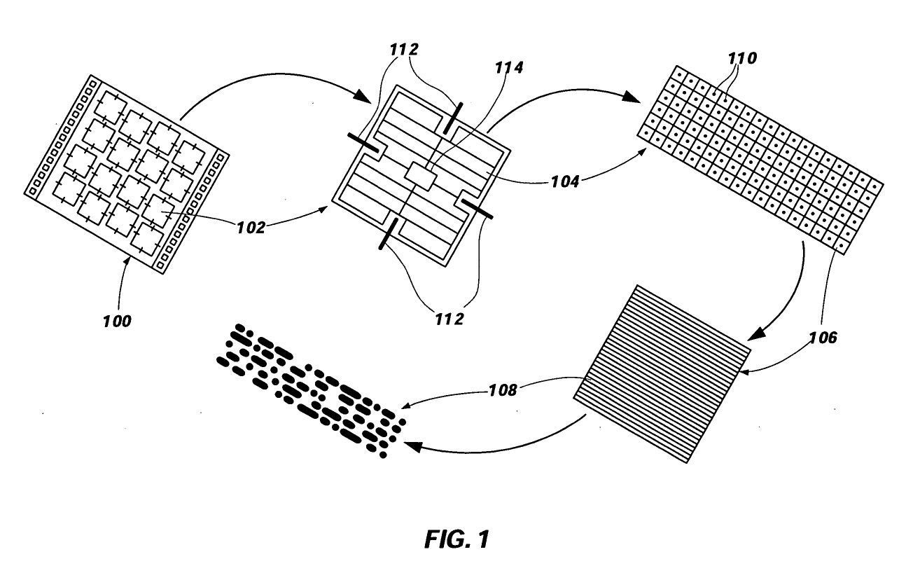

FIG. 1 is a diagram illustrating an embodiment of a memory module 100. Memory module 100 includes a plurality of movers 102. Each mover 102 includes a plurality of clusters 104. Each cluster 104 includes a plurality of patches 106, and each patch 106 includes a plurality of tracks 108.

In the embodiment shown in FIG. 1, memory module 100 includes sixteen movers 102. Movers 102 each include sixteen clusters 104. Clusters 104 each include one hundred eight patches 106, and patches 106 each include one thousand tracks 108. In other embodiments, memory module 100 includes other numbers of movers 102. Movers 102 each include other numbers of clusters 104. Clusters 104 each include other numbers of patches 106, and patches 106 each include other numbers of tracks 108.

Memory module 100 comprises a storage device configured to store information. The information may include instructions and/or data processable by a processing system, such as a computer system, as well as other types of information such as servo information as described herein. The information is stored along the plurality of tracks 108 which run in parallel with each other in each patch 106. A read/write mechanism 110, such as an electron beam and sense diode, is associated with each patch 106 and is configured to read and write information along tracks 108 in a respective patch 106.

Each mover 102 includes a plurality of flexures 112 configured to support or enable motion of a mover 102 as its position is changed or adjusted. In particular, flexures 112 of a mover 102 support the mover 102 as it is moved relative to the plurality of read/write mechanisms 110 to allow information to be read and written along each of the tracks 108 in each of the patches 106 in each of the clusters 104 of the mover 102.

In the embodiment of FIG. 1, mover 102 includes fifteen data clusters 104 and one servo cluster 114. Servo cluster 114 includes four patches 106 (not shown) that include servo information as described herein below. The four patches 106 each have an associated read/write mechanism 110 that is configured to read and write the servo information. Each mover 102 in the embodiment shown includes a servo cluster 114 as just described. In other embodiments, mover 102 may include other numbers of data clusters 104 and servo clusters 114.

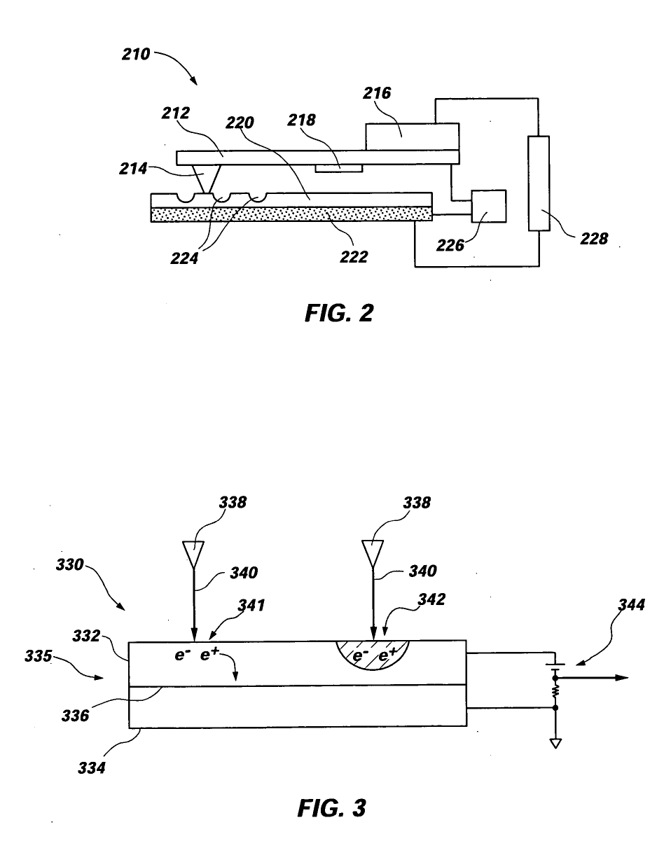

Looking next at FIGS. 2 and 3, two embodiments of data storage and retrieval systems are shown, with which the current invention may be used. FIG. 2 discloses a contact data detection system 210 used for reading data locations such as pits. System 210 includes an elongated cantilever 212 having a pointed probe 214 and mounted on a silicon surface 216. A stress bar 218 is mounted on the underside of cantilever 212 to bias the cantilever downward. Cantilever 212 is poised above a recording media 220, mounted on a substrate 222 and having a plurality of data pits 224 therein. A translation drive circuit 226 is connected between the cantilever 212 and the substrate 222 to cause relative horizontal movement between the two elements, so that the cantilever can read multiple rows of data pits 224. Drive circuit 226 may be used to drive a micro-electrical mechanical (MEM) mover (not shown) commonly used in ARS data storage systems.

A sensing circuit 228 is connected between substrate 222 and silicon surface 216 for sensing the presence of data by movement of the cantilever 212. Sensing circuit 228 detects data pits 224 by generating a signal representative of the cantilever 212 detecting a data pit 224 by dropping into the pit 224, as shown in FIG. 1B. A sensing signal representative of the data pit 224 may be generated in a number of ways, including sensing a difference in electrical fields or a variation in resistivity of the cantilever 212.

Looking now at FIG. 3, a data storage and retrieval system 330 is shown involving photodiode (light beams) or cathododiode (electron beams) emitters and a diode detector system. A data storage layer 332 is disposed on an additional layer 334 to form the diode 335. The diode can be any type that provides a built-in field for separating charge carriers, such as a p-n junction, pin-junction or Schottky barrier device, depending on the materials used.

Emitters 338 direct light beams or electron beams onto the storage layer 332. A data bit is written by locally altering the state at areas 342 of the storage layer 332. The different states of the storage areas 342 provide a contrast in bit detection during the read function. During the read function, the emitters 338 emit a lower power density beam to locally excite charge carriers in the storage areas 341 and 342 of the diode 335. If carriers are excited in the storage layer 332, the number of carriers created will depend on the state of the storage areas 341, 342 where the light or electron beams 340 are incident. An additional field may be applied across interface 336 by a voltage source 344. The current that results from carriers passing across the diode interface 336 can be monitored by a detection signal taken across the interface 336 to determine the state of data storage areas 341, 342.

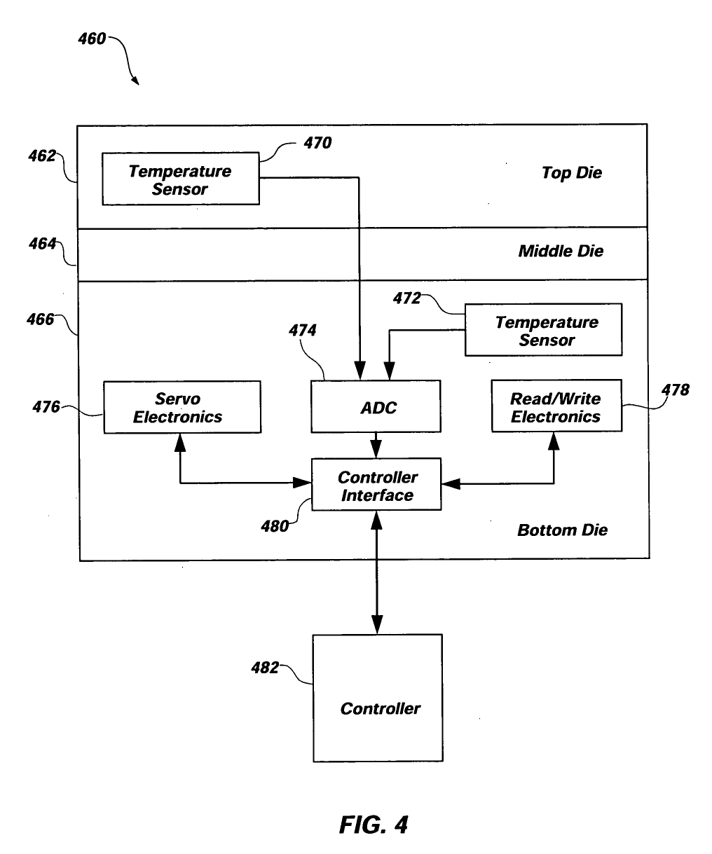

Referring now to FIG. 4, a block diagram shows the structure of a module temperature sensing system 460, according to the present invention. System 460 includes a top die 462, a middle die 464 and a lower die 466, all having electrical interconnections between the dies. The top die 462 contains the cantilevers and probes (not shown) used to write and read the media and also contains a first temperature sensor 470. On the middle die 464, the media for data storage and detection is located (not shown). The media may be placed on micro-electromechanical mover systems (MEMS) (not shown) also located on the middle die 464.

The bottom die contains most of the module electronics, namely a second temperature sensor 472, an analog-to-digital (ADC) unit 474, conventional servo electronics 476, conventional read-write electronics 478 and a controller interface 480. A conventional controller 482 is disposed at some location separate from the dies. The first temperature sensor 470 and the second temperature sensor 472 feed into ADC unit 474, which then provides the detected temperatures to the controller interface 480. Two-way electrical communication also flows occurs between the controller interface 480 and the servo electronics 476 and read-write electronics 478.

The temperature detectors 470 and 472 are used to determine whether there are temperature variations between the top die 462 and the bottom die 466. The die and the apparatus thereon are sensitive to temperature changes, usually by expanding as the temperature increases and contracting as the temperature decreases. It is critical to have the top die 462, containing the writing and reading devices, strictly aligned with the middle die 464 containing the recording media. Thus, it is important to be able to detect any substantial temperature differences between dies 462 and 464 that might cause a misalignment between the two dies.

It would be more accurate to place a temperature sensor in the middle die 464 instead of in the bottom die 466. However, this would substantially increase the manufacturing costs because of additional processing steps required. Accordingly, in the present embodiment, a temperature sensor 472 is placed in the bottom die 466 instead of the middle die 464, because of the ease in doing so. In another embodiment, temperature sensor 472 or an additional temperature sensor may be placed in the middle die 464 during or after the fabrication process.

Substantial temperature differences between the top die 462 and the middle die 464 are the most critical during the writing process. In the reading process, if misalignment occurs, data error feedback may be used to implement corrections in the servo system. However, in the writing process, a misalignment may lead to over-writing an adjacent track, thereby destroying the data in that track. Acccordingly, the measured differences in temperature between the top die 462 and the bottom die 466 can be used to either shut down the write process until temperature differences stabilize or can be used in an algorithm to adjust the servo system to keep the data writing devices on track. The temperature difference may also be used to conduct a servo calibration routine.

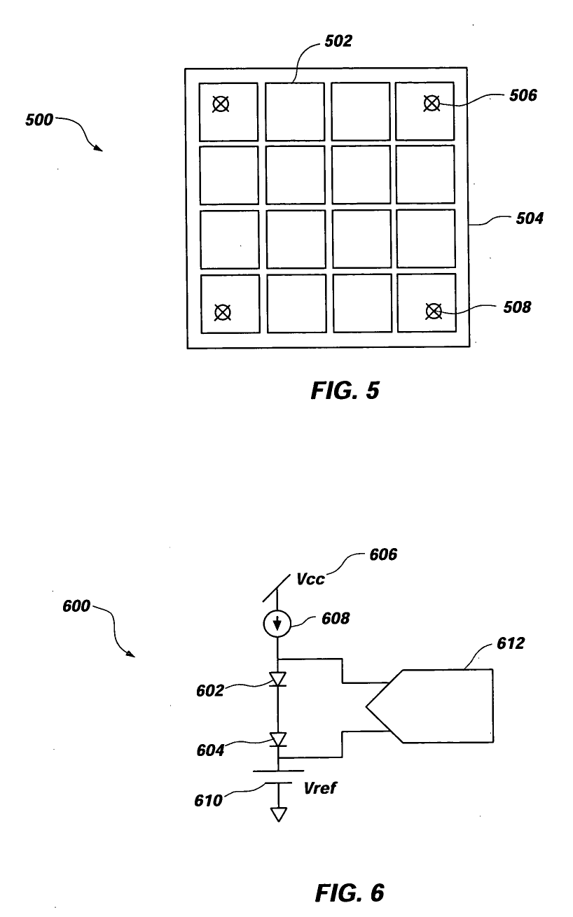

Looking now at FIG. 5, a memory module 500 is shown, similar to memory module 100 in FIG. 1. Memory module 500 includes an array of movers 502. Movers 502 are disposed on a middle die 504, similar to the middle die 464 in FIG. 4. The module shown forms a 100 mm square with sixteen movers in a four by four array. Many other array structures are possible.

Directly beneath the middle die with movers 502 is a bottom die (not shown) having electronics and other components, similar to the bottom die 466 shown in FIG. 4. The bottom die has four temperature sensors 506 denoted by the “O” in each of the four corners of module 500. Directly above the middle die containing the movers 502 is a top die (not shown) similar to die 462 in FIG. 4 and having read/write apparatus thereon. The top die has four temperature sensors 508, denoted by the “X” in each of the four corners of module 500. Accordingly, in this embodiment there are a total of eight temperature sensors, four on each of the corners of the top and bottom die, that provide temperature related data to a controller or other data processing apparatus to determine whether the measured temperature changes are within tolerated limits.

As illustrated, the temperature sensors 508 in the top die are positioned directly over the temperature sensors 506 in the bottom die, so that temperature sensing can be conducted in the same location on both dies. An alternate embodiment includes temperature sensors at the four corners of middle die 504, in place of, or in addition to, temperature sensors 506 and/or 508.

Referring now to FIG. 6, a temperature sensor circuit 600 is shown, suitable for use as the temperature sensors 470 and 472 in FIG. 4 and temperature sensors 506 and 508 in FIG. 5. Circuit 600 includes two forward biased diodes 602 and 604 in series with a supply voltage 606 and a current generator 608. A reference voltage 610 is provided to raise the reference voltage of circuit 600 to a suitable level.

Two diodes 602 and 604 are used to provide better sensitivity. Diodes 602 and 604 may each have a temperature sensitivity of about 2 mv/deg.C with a voltage drop of 0.65 volts DC. The output of the voltage drop across diodes 602 and 604 is fed to an analog-to-digital (ADC) converter 612, similar to ADC 474 in FIG. 4.

By using two diodes, the temperature sensitivity of the circuit increases to 4 mv/deg.C with a combined voltage drop of 1.4 volts DC, which may provide suitable sensitivity in the present memory module application. Obviously, other combinations of one or more diodes may be used in other applications. Furthermore, many other circuits may be used to provide suitable temperature sensitivity, including a circuit having an integrated resistor and measuring the change in voltage as a result of the resistance change due to temperature.

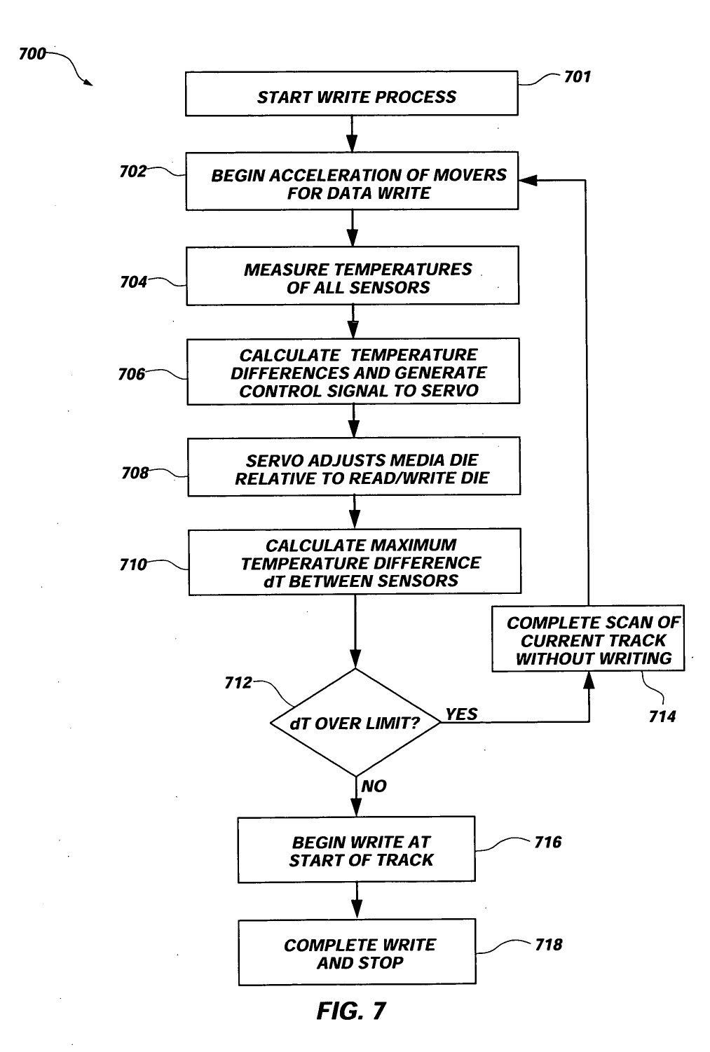

Looking now at FIG. 7, a flow diagram is shown of a write process 700 that may be implemented in the present invention. Reference is also made to FIG. 4 with respect to certain elements therein. The system begins the write process at step 701. At step 702, the middle die 464 containing a plurality of movers begins to accelerate up to a speed suitable for the write apparatus on top die 462 to write data in the data tracks of the media disposed on the movers. For context, the acceleration time might be about 300 microseconds, and the speed of the movers might be about 10 mm/sec.

During this acceleration time, the temperatures are measured at each of the temperature sensors 470 and 478 at step 704. The temperature information is fed to the controller 480 that determines temperature differences between the top read/write die 462 and the bottom electronics die 466. The controller 482 uses an algorithm to calculate the likely misalignment between the top die 462 and the middle media die 464 caused by these temperature differences that would affect the writing function and possibly endanger adjacent tracks of data. If an adjustment in alignment of the die is needed, the controller 480 generates a control signal, at step 706. In response to the control signal, at step 708, the servo mechanism may adjust the media die 464 relative to the read/write die 462, or adjust the read/write die 462 relative to the media die 464, to maintain alignment of the read/write die 462 to the media die 464 for the write process.

The temperature information in the controller 482 is also used to calculate maximum differences in the temperatures sensed at each of the sensors at 706. At step 710, a temperature difference dT which is used to determine whether the system is operating within safe limits. One way of determining dT is to determine the temperature differences between sensor pairs on the two die where the sensors are located. Thus, referring to FIG. 5, each sensor pair 506, 508 in each of the corners of the upper and lower dies (not shown) is measured to determine which pair has the largest temperature difference. The largest difference could become dT.

Another method for determining dT is to use various other combinations of pairs of sensors between the two die where the sensors are located, or to use various combinations of pairs of sensors on the same die, in some instances. Alternatively, one might calculate the average of all the sensor temperatures on the read/write die, then calculate the average of all the sensor temperatures on the media or electronics die, and finally calculate dT by taking the difference between the averages. Other such variations might be used to determine a critical temperature difference that could then be applied to determine whether a safe limit of operation has been exceeded. In all cases, it is likely that the sensors being compared are previously calibrated to establish accurate readings.

The controller utilizes an algorithm to calculate whether this temperature difference dT is above suitable limits. Typically, such a limit might be exceeded at two to three degrees C. These calculations may include a determination of the likely amount of expansion or contraction of the top die, middle die and/or bottom die in response the measured temperature variations. A variety of additional different temperature measurements may be made and used in a variety of different calculations, as needed, within the scope of the present invention.

At step 712, a determination is made as to whether the temperature difference dT is above suitable limits. If so, the system scans through the current track without writing, at step 714. It then cycles back to step 702 to again begin acceleration for the write process. This cycle may continue until the temperature difference dT comes under a maximum limit. Alternately, the system may be shut down and the movers stopped until a satisfactory dT can be measured. At the time that dT is determined to be within suitable limits, the system may proceed with the writing process, at step 716. The write process may need be delayed temporarily until the system reaches the start of a data track. The write operation then proceeds to completion and stops, at step 718.

It should be understood that the temperature sensors 470 and 472 would likely have undergone initial calibration during or after fabrication, so that any temperature differences inherent in the circuitry or fabrication materials will have been taken into account. Additional calibration may also take place periodically in the field, to account for ambient temperature variations and changes that may arise due to continual use of the circuitry.

Another variation in process 700, may be to determine differences in temperature between different sensors or differences in temperature of a specific temperature sensor over a period of time. For example, if dT is measured at different intervals, a dynamic picture could be shown that would indicate a trend toward exceeding a desirable limit. This approach would provide a warning and even an early shut down, if necessary. Another change in process 700 may be to compare the temperatures of specific temperature sensors located on one or more of the die to try to isolate alignment problems.

The read process is not shown here, but would be similar to the write process 700. However, the read process may not require a read interrupt in the event that dT exceeds a predetermined limit, since the read process would not destroy or interfere with data on adjacent tracks. Accordingly, alignment adjustments in reading a track would probably suffice.

It should be understood that the method and system of the present invention may be used for data storage systems having other embodiments besides those shown herein. For example, magnetic data storage media may be used to store data. In such systems, the present invention may be applied to develop a control signal to compensate for inadvertent ambient temperature changes that will affect the accuracy and viability of apparatus used in sensing and writing data.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A data recording module having an electronics die and a read/write die for writing and detecting data in a media die adjacent to the read/write die, the module comprising:
(a) a first temperature sensor disposed in the read/write die to measure a first temperature at the read/write die,
(b) a second temperature sensor disposed in the electronics die or the media die to measure a second temperature at the electronics die or the media die, and
(c) a controller in electrical communication with the first and second temperature sensors, to generate a control signal to the electronics module in response to a difference between the first and second temperatures.

2. The data recording module of claim 1, further comprising adjusting means associated with the controller and responsive to the control signal for responding to the control signal for adjusting positions of the read/write die relative to the media die.

3. The data recording module of claim 2, wherein the adjusting means comprises servo means in communication with the controller and with the read/write die and/or the media die to adjust the positions of the read/write die relative to the media die in response to the control signal.

4. The data recording module of claim 2, wherein the controller includes an algorithm for relating the difference between the first and second temperatures to an adjustment in positions of the read/write die relative to the media die, to be reflected in the control signal.

5. The data recording module of claim 4, wherein the algorithm adjusts a time of writing and/or detecting data on the adjacent media die.

6. The data recording module of claim 1, further comprising read/write means connected to the controller to stop and start data recording by the read/write die in response to the control signal.

7. The data recording module of claim 1, wherein the controller determines a change in the read/write die temperature and/or the electronics die temperature over time.

8. The data recording module of claim 1, further comprising an analog to digital converter disposed between the first temperature sensor and the controller and between the second temperature sensor and the controller.

9. The data recording module of claim 1, wherein the first temperature sensor and/or the second temperature sensor includes at least one forward-biased diode circuit.

10. The data recording module of claim 1, wherein the first temperature sensor and/or the second temperature sensor includes at least one integrated resistor circuit.

11. The data recording module of claim 1, wherein the read/write die includes a cantilever and probe for writing and detecting data in contact with the adjacent media die.

12. The data recording module of claim 1, wherein the read/write die includes a plurality of energy emitters for emitting electron or light beams to the adjacent media die for writing and detecting data.

13. A data recording module having a read/write die for writing and detecting data in an adjacent media die, and having an electronics die, comprising:
(a) a first plurality of temperature sensors disposed in the read/write die to measure a first plurality of temperatures,
(b) a second plurality of temperature sensors disposed in the electronics die or the media die to measure a second plurality of temperatures, and
(c) a controller in electrical communication with the first and second plurality of temperature sensors, for generating a control signal to the electronics module in response to a difference between the first and second plurality of temperatures.

14. The data recording module of claim 13, wherein the first plurality of temperature sensors are aligned with the second plurality of temperature sensors.

15. The data recording module of claim 13, wherein the first plurality of temperature sensors are disposed in corners of the read/write die, and the second plurality of temperature sensors are disposed in corners of the media die or the electronics die.

16. The data recording module of claim 13, further comprising a servo means connected to the controller and to the read/write die and/or the media die to adjust positions of the read/write die relative to the media die in response to the control signal.

17. The data recording module of claim 13, wherein controller determines maximum and minimum temperatures in the first set of temperatures and the second set of temperatures.

18. The data recording module of claim 17, wherein the controller generates the control signal when a delta difference between the maximum and minimum temperatures is more than a predetermined limit.

19. The data recording module of claim 18, wherein the controller generates a control signal to deactivate read/write activity in the read/write die until the delta difference is less than the predetermined limit.

20. The data recording module of claim 19, wherein the read/write activity of the read/write die comprises writing data in a plurality of data tracks, and wherein the controller generates a control signal for the read/write activity to begin only at a beginning of a data track.

21. A method for writing and detecting data using a data recording module having a read/write die, a media die, and an electronics die, comprising:
(a) measuring a first temperature with a first temperature sensor disposed in the read/write die,
(b) measuring a second temperature with a second temperature sensor disposed in the electronics die or the media die, and
(c) generating a control signal in response to a difference between the first and second temperature.

22. The method of claim 21, further comprising compensating for the difference between the first temperature and the second temperature using an adjusting means responsive to the control signal.

23. The method of claim 22, further comprising adjusting positions of the read/write die and/or the media die in response to the control signal.

24. The method of claim 22, wherein the adjusting step comprises utilizing an algorithm for adjusting positions of the read/write die and/or the media die in response to the control signal.

25. The method of claim 21, further comprises writing data in a data track on the media die only if the difference is under a predetermined limit.

26. The method of claim 21, further comprising measuring changes in the read/write die temperature and in the media die temperature and/or the electronics die temperature over time, and generating the control signal in response to said temperature changes over time.

27. A method for writing and detecting data using a data recording module having a read/write die, a media die and an electronics die, comprising:
(a) measuring a first plurality of temperatures with a first plurality of temperature sensors disposed in the read/write die,
(b) measuring a second plurality of temperatures with a second plurality of temperature sensors disposed in the electronics die or the media die, and
(c) generating a control signal in response to a difference between the first and second temperature.

28. The method of claim 27, further comprising compensating for the difference between the first plurality of temperatures and the second plurality of temperatures using an adjusting means responsive to the control signal.

29. The method of claim 28, further comprising adjusting the positions of the read/write die and/or the media die in response to the control signal.

30. The method of claim 29, wherein the adjusting step comprises utilizing an algorithm for converting the difference in temperature to an adjustment in the positions of the read/write die and/or the media die in response to the control signal.
